(19) United States
(12) Patent Application Publication
(10) Pub. No.: US 2022/0366733 A1
(43) Pub. Date: Nov. 17, 2022

(54) METHOD FOR MONITORING THE OPERABILITY OF A VEHICLE, CONTROLLER FOR A DRIVE OF A VEHICLE, DRIVE HAVING SUCH A CONTROLLER, AND VEHICLE HAVING SUCH A DRIVE

(71) Applicant: Rolls-Royce Solutions GmbH, Friedrichshafen (DE)

(72) Inventors: Thomas Kottke, Ehningen (DE); Tobias Frank, Friedrichshafen (DE)

(73) Assignee: Rolls-Royce Solutions GmbH, Friedrichshafen (DE)

(21) Appl. No.: 17/866,268

(22) Filed: Jul. 15, 2022

Related U.S. Application Data
(63) Continuation of application No. PCT/EP2021/050835, filed on Jan. 15, 2021.

(30) Foreign Application Priority Data
Jan. 17, 2020 (DE) 10 2020 200 568.0

(51) Int. Cl. G07C 5/04; B60T 17/22; B61C 5/00; B61L 27/57

(52) U.S. Cl. CPC G07C 5/04; B60T 17/228; B61C 5/00; B61L 27/57; B60T 2201/04

(57) ABSTRACT

A method for monitoring an operability of a vehicle, the method including the steps of: traveling a route, which is defined, with the vehicle; detecting at least one power parameter of the vehicle, the at least one power parameter being characteristic for a power of a drive of the vehicle; comparing, in a first comparison, the at least one power parameter with historical data regarding the route traveled; and evaluating the operability of the vehicle based on the first comparison.

### CROSS REFERENCE TO RELATED APPLICATIONS

This is a continuation of PCT Application No. PCT/EP2021/050835, entitled “METHOD FOR MONITORING THE OPERABILITY OF A VEHICLE, CONTROLLER FOR A DRIVE OF A VEHICLE, DRIVE HAVING SUCH A CONTROLLER, AND VEHICLE HAVING SUCH A DRIVE”, filed Jan. 15, 2021, which is incorporated herein by reference. PCT Application No. PCT/EP2021/050835 claims priority to German Patent Application No. 10 2020 200 568.0, filed Jan. 17, 2020, which is incorporated herein by reference.

### BACKGROUND OF THE INVENTION

### 1. Field of the Invention

The present invention relates to a method for monitoring the operability of a vehicle, a controller for a drive of a vehicle, a drive having such a controller, and a vehicle having such a drive.

### 2. Description of the Related Art

The operability of a vehicle may be impaired in various ways. It is possible that a drive of a vehicle—for example as a consequence of aging, wear and/or contamination—exhibits reduced power, or that power losses occur in other places, for example as a consequence of a defective brake system, in particular if brakes of the vehicle jam. If the drive of the vehicle has a plurality of drive units it is desirable to be able to detect which of the drive units exhibits an impaired operability. It is problematic that an output power of a vehicle, in particular in the case of a rail vehicle the actual propulsive power applied to the rail, cannot be determined, or can only be determined at great expense.

What is needed in the art is a method for monitoring the operability of a vehicle, a controller for a drive of a vehicle, a drive having such a controller, and vehicle having such a drive, wherein the aforementioned disadvantages do not occur, and wherein in particular a simple and at the same time precise evaluation of the operability and/or a possibility of identifying—in the case of a plurality of drive units—the specific drive unit or the specific drive units which is/are impaired in their operability is/are to be provided.

### SUMMARY OF THE INVENTION

optional that the present invention provides, according to a first aspect of the invention, a method for monitoring the operability of a vehicle, said method including the following steps: A certain route is driven with the vehicle. At least one—in particular current route-related—power parameter of the vehicle which is characteristic for a power of the drive of the vehicle, is detected. In a first comparison, the at least one detected power parameter is compared with historic data which is available for the route, in particular the route traveled, and the operability of the vehicle is evaluated on the basis of the first comparison. This approach facilitates in particular a simple estimation or determination of the actual propulsive power based on the detected power parameter, or it can at least be assessed—by comparing the power parameter with historical data regarding the same route—whether the vehicle's operability is within an expected range, based on the historical data, or in particular whether it has decreased. Advantageous use is made of the fact that vehicles, in particular rail vehicles or mining vehicles, typically travel the same routes repeatedly, whereby it can be further assumed that under certain conditions, which will be explained in more detail below, the power output is comparable. Therefore, information about the vehicle's operability can be obtained, in particular, from comparing the at least one power parameter with historical data regarding the same route.

In particular, an operability of a vehicle which regularly travels the same route, as intended, is optionally monitored. Therein, the aforementioned advantages are realized in a particular manner. Optionally, an operability of a rail vehicle or a mine vehicle is being monitored. Such vehicles typically travel the same route repeatedly, in particular regularly.

A rail vehicle—sometimes also referred to as rolling stock—is understood in particular as a vehicle which is driven or guided on at least one rail, in particular on several rails, in particular on two rails. In particular, the rail vehicle is optionally a train, multiple unit, railcar, locomotive, rail tractor, rail service vehicle, monorail vehicle, overhead rail vehicle, driverless track guided passenger rapid transit (PRT) vehicle, or another rail-bound vehicle. Such vehicles are frequently used repeatedly, in particular regularly on the same route.

A mining vehicle is in particular understood to be a vehicle used in the mining industry, especially in surface mining, in particular to transport overburden or mined material, for example mineral resources. Such mining vehicles are typically moved repeatedly along the same route, for example, from a deposit site to a mining site of a mine and back again. In an optional embodiment, the vehicle is a dump truck.

The vehicle drive optionally has a plurality of drive units and is thus equipped with a multi-motor drive. The multiple drive units can herein be arranged in a single compartment of the vehicle, in particular the rail vehicle, in particular a locomotive or a rail car; it is however also possible that the multiple drive units are distributed over a plurality of compartments of the vehicle, in particular over various carriages of a train, as in the case for example, with the ICE 3, which has an underfloor drive distributed over the entire train.

The drive has optionally at least one internal combustion engine and/or at least one electric machine. If the drive is designed as a multi-motor drive, each of the drive units of the plurality of drive units has optionally its own internal combustion engine and/or electric machine. It is therein possible, that the propulsive power is provided directly by the internal combustion engine and is transferred to at least one driven axle. The drive may however also be designed as an electric drive with battery and/or fuel cell as the energy supplier. The energy provided by an internal combustion engine is however, especially optionally converted and made available to the driven axle in another form, in particular in that the drive or a drive unit of the drive is designed as internal combustion-electric or internal combustion-hydraulic, in particular diesel-electric or diesel-hydraulic. It is in particular possible, that all drive units of a multi-engine system are designed as internal combustion-electric drive units or as internal combustion-hydraulic drive units. It is also possible that the drive, or at least one drive unit is designed as a hybrid drive or as a hybrid drive unit, in particular in the sense defined below, in particular as a parallel hybrid.

It is in particular possible that each drive unit of a multi-motor system is designed as a hybrid drive unit.

An internal combustion-electric drive or an internal combustion-electric drive unit is understood to be a design wherein an internal combustion engine drives a generator, wherein mechanical energy provided by the internal combustion engine is converted by the generator into electric energy. This electric energy is supplied to at least one electric motor which drives at least one axle of the vehicle as a driven axle.

Internal combustion-hydraulic is understood in particular, in that an internal combustion engine drives a hydraulic pump, so that the mechanical energy provided by the internal combustion engine is converted into hydraulic energy. This is provided to at least one hydraulic motor, which then drives at least one driven axle of the vehicle.

In contrast, a hybrid drive or a hybrid drive unit is understood to be a design, wherein an internal combustion engine interacts with an electric machine in such a way, that mechanical propulsive power may be provided optionally only by the internal combustion engine, only by the electric machine, or together by the electric machine and the internal combustion engine (parallel hybrid). An electric storage device is optionally assigned to such a hybrid drive, so that in particular operating states are possible in which the electric machine is operated—without the involvement of the internal combustion engine or in addition to the internal combustion engine—with the supply of electric energy from the storage device. In other operating states it is possible, that the internal combustion engine drives the electric machine as a generator, optionally charging the electric storage device. In particular, if the hybrid drive or the hybrid drive unit has two electric machines, an internal combustion-electric operation—quasi as a special case—is also possible as an operating state, wherein the internal combustion engine drives one of the two electric machines which then acts as a generator and provides the electric energy which is supplied to the other electric machine of the two electric machines operated as a motor, which in turn can then drive a driven axle.

Optionally, the route on which the vehicle travels is determined within the scope of the method. The fact that it is determined on which route the vehicle travels means in particular, that the route is specified, or that the route is recognized. According to an optional design it is possible in this respect for the route to be communicated to a controller of the vehicle before the vehicle travels on it, in particular to be entered into the controller or transmitted to the controller, for example to be sent to the controller through a network or downloaded from a network. Alternatively, or in addition, the route is recognized in the vehicle during travel on the route. In particular, the route is optionally recognized by way of satellite-supported navigation, for example GPS and/or through pattern matching, in particular by way of detected power parameters and/or speed and/or acceleration data along the route, compared to relevant historic data.

A power parameter is understood in particular, to be a parameter that is characteristic of a current or route-related power of the vehicle's drive. A current power is understood to mean in particular a power output of the drive at a given point in time. A route-related power is understood to mean, in particular, a power of the drive on a specific section of the route.

According to an optional design, the at least one detected power parameter is stored in the vehicle. In this case it is possible, in particular, that also the first comparison is conducted locally in the vehicle. Alternatively, or in addition, the at least one power parameter is transferred optionally via a network, in particular via the internet, to a central service provider, also referred to as a server. It is possible that in this case in particular the first comparison is also performed on the central service provider.

In order to be able to conduct the first comparison in the vehicle, it is optionally provided that the historical data is also stored in the vehicle, or that the historical data is transferred from the central service provider—in particular via the network—to the vehicle, in particular that it is downloaded.

Historical data is understood, in particular to be data acquired in the past on the particular route, in particular values acquired in the past for the at least one power parameter, drive data relating to the drive, loading data characterizing a cargo of the vehicle, and/or environmental data characterizing environmental or surrounding conditions, such as an air pressure or an air temperature.

The fact that the at least one power parameter is compared with historical data available for the same traveled route means in particular that historical data is compared with the at least one power parameter in a route-section based manner. The historical data is also optionally detected respectively for a specific route section and is compared with the at least one power parameter for the same route section.

The historical data was optionally detected in the past by the same vehicle in which or for which the process is conducted. Alternatively or in addition, it is possible that the historical data was detected by another, optionally identical or at least similar vehicle, in particular a fleet vehicle from a fleet of vehicles. Alternatively or in addition, it is possible that mean values of a fleet of vehicles are used as historical data.

A further development of the invention provides, that a target power specification for the vehicle, in particular for the drive of the vehicle, is compared in a second comparison along the traveled route with the at least one detected power parameter, wherein the operability of the vehicle is additionally evaluated on the basis of the second comparison. From the comparison of the target power specification with the detected power parameter, it can be concluded whether and/or to what extent the vehicle actually delivers the specified target power.

A target power specification is understood to mean in particular a specification by an operator, in particular a driver of the vehicle, for the target power to be provided. The target power specification can in particular be a speed step, a torque requirement and/or a speed requirement. The target power specification can in particular correspond to a current position of a control lever or accelerator pedal or be specified by such a lever or pedal position.

The fact that the target power specification along the traveled route is compared with the at least one detected power parameter means, in particular, that the comparison is conducted in a route-section based manner. Typically, the target power is specified in relation to the route section, in particular differently for different route sections, whereby the power parameter is also detected in relation to the route section. If, for example, certain speed is to be maintained, a higher target power is typically specified for the vehicle on an ascending slope section of the traveled route than for a descending slope section or for a horizontal section of the traveled route.

The target power specification is compared with the at least one detected power parameter, in that it is correlated with the at least one power parameter.

Optionally, a comparison result resulting from the second comparison is compared with corresponding historical data, that is historical data for the comparison result, and/or for the target power specification and the at least one detected power parameter, wherein this comparison is additionally used to evaluate the operability of the vehicle. It can thus be determined in particular, if a change in the ratio between target power specification on the one hand, and the at least one detected power parameter on the other hand occurs, which indicates a change in the operability of the vehicle. If, for example, in a certain section of the traveled route—at a constant target power specification—the at least one detected power parameter indicates a reduced or decreasing power of the vehicle, this would indicate an impairment of the vehicle's operability.

According to a further development of the invention, it is provided that the traveled route is verified while it is traveled on by the vehicle. It can thus be advantageously determined, whether the specified route is in fact being traveled, or whether deviations between the route specification and the actually traveled route exist. This is especially advantageous, if the route is transferred or input by the operator, in particular the driver of the vehicle prior to travel commencement, wherein erroneous inputs or transfer errors cannot be completely excluded. If, during the verification it is determined that the specified route is in fact being traveled, the route specification can be confirmed. Otherwise, the specified route can possibly be replaced with the recognized, actually traveled route. The traveled route is optionally verified with historic data or data patterns by way of navigation data, in particular satellite navigation data, in particular GPS data, and/or through pattern matching of the detected at least one power parameter. It can be seen that in particular a temporal progression of the at least one power parameter along the traveled route—in particular route section related—is characteristic for the traveled route. For example, sequences of traveled gradients and horizontal route sections are reflected in the route section-related progression of the at least one detected power parameter.

According to a further development of the invention it is provided, that as the at least one power parameter, a parameter is detected which is selected from a group consisting of: a target power specification; a speed of the vehicle—in particular current or averaged over a section of the route, in particular detected as a moving average; an acceleration of the vehicle—in particular current or averaged over a section of the route, in particular detected as a moving average; an injection time of an internal combustion engine of the drive of the vehicle; a rotational speed of the internal combustion engine; and a selected gear of a transmission of the drive of the vehicle. These parameters, individually and in combination with one another are characteristic for the current or route-related power of the vehicle. Optionally at least two power parameters from the aforementioned group are detected. In an optional design, all power parameters of the aforementioned group are detected. In particular, the power of the vehicle's drive can be inferred from a plurality of power parameters, most especially from all of the specified power parameters.

An injection time of the internal combustion engine is understood in particular as a time value selected from a group consisting of injection start, injection end, and injection duration. These time parameters allow conclusions to be drawn regarding the amount of fuel supplied to a combustion chamber of the internal combustion engine and thus regarding the chemical energy supplied to the internal combustion engine in a working cycle.

“Injection” is herein understood generally as the supply of fuel to a combustion chamber of the internal combustion engine, regardless of whether a liquid fuel or a gaseous fuel is supplied, and regardless of whether the injection occurs as single point injection, multi-point injection or direct injection. The terms “time”, “time value” and “time parameter” are not limiting to values of units of time; rather, values specified in degrees of crankshaft angle (° KW) can also be used equivalently, whereby corresponding values with the unit of a time and such values in degrees of crankshaft angle can be converted into one another via the speed of the internal combustion engine.

According to a further development of the invention it is provided, that during a first and/or second comparison,—in particular current—load of the vehicle is considered. This allows for greater reliability in the evaluation of the operability of the vehicle. In particular, if a certain route is always to be traveled at the same route-section related speeds in order to adhere to a time schedule, the power to meet this requirement varies with the load of the vehicle. Considering the load when assessing the operability thus prevents a higher vehicle load from being incorrectly misinterpreted as a reduced operability of the vehicle.

The load is optionally determined by reading out historical load data depending on time and location, in particular a current time and location of the vehicle. This allows an evaluation of the actual load from the previously determined values. This is based on the idea that the use of vehicles, especially rail vehicles, is subject to a certain regularity—both in terms of time and location—due to, for example commuter traffic.

Alternatively or in addition, the load is optionally determined by evaluating a recuperated energy if the vehicle has a recuperative drive as its drive. The recuperated energy, especially when descending a slope or decelerating, depends on the mass and thus also on the load of the vehicle. The mass of the vehicle which differs due to the different load can thus be determined by determining the recuperated energy. A recuperative drive is in particular a drive designed to recover and store kinetic energy of the vehicle, in particular during deceleration or when descending a slope, in particular in the form of electrical energy. A recuperative drive can in particular be a hybrid drive or a drive with fuel cell or battery.

Historic load data is optionally obtained by direct or indirect detection of the vehicle load and allocation of time and location information to the detected load. Indirect determination of the load can occur—especially with a rail vehicle—in particular in that, at stopping points, in particular at railway stations, the number of boarding or disembarking passengers is determined for the rail vehicle. This can be done in particular by image analysis, for example from surveillance cameras, or by estimating the load on the basis of redeemed tickets. The mass of the luggage carried can also be estimated at least roughly on the basis of image evaluation. This can occur in particular by image analysis, for example from surveillance cameras, or by estimating the load based on redeemed tickets. The mass of the luggage carried can also be estimated at least roughly, on the basis of image evaluation.

According to a further development of the invention, it is provided that when an impairment of the operability of the vehicle is detected, it is checked whether the impairment is present in the drive or in a brake system of the vehicle. In this way, the cause of the impaired operability can be further limited, wherein it can be determined in particular, whether a brake is jammed or whether the drive has reduced power, for example due to defects, wear, aging or the like.

The check is optionally performed on the basis of a behavior during a slope descent and/or a deceleration behavior of the vehicle. In this respect, an impairment of the operability of the brake system, especially jamming of a brake, can be determined by a changed behavior during a slope descent and/or during deceleration. Slope descent and deceleration both, represent operating states in which the drive provides no or at most little propulsive power, with the behavior of the vehicle essentially being determined by the braking system. If a brake jams, the speed of the vehicle decreases for example more quickly when descending a slope or coasting than when the brake system is fully functional, in other words, when no brake is jammed. Thus, in particular, by comparing the current slope descent behavior and/or deceleration behavior with historical data for slope descent behavior and/or deceleration behavior, it is possible to determine whether there has been a change in the behavior of the vehicle and thus ultimately an impairment of the braking system.

Alternatively, or in addition the check is optionally conducted in that—in a third comparison—the recuperated energy is compared with expended energy of the vehicle, in particular by considering historical data, if the vehicle has a recuperative drive. In particular, it is checked whether the behavior of the recuperated energy with regard to historical data for the recuperated energy corresponds to the behavior of the expended energy with regard to historical data for the expended energy. This is based on the consideration that, if the same route is traveled several times with the same energy expenditure, the recuperated energy should also remain the same. If the expended energy changes, for example due to a changed load, or due to a changed vehicle speed, the recuperated energy should change accordingly in the same sense, in particular it should increase or decrease in the same direction as the expended energy. If this is not the case, it can be concluded that the vehicle's operability is impaired. A further distinction can be made as to whether the impairment is in the drive or in the brake system of the vehicle:

For example, if—compared to historical data—the energy expended at the same speed of the vehicle is higher, but the recuperated energy is lower, this is an indication that a brake is jammed and thus the impairment is in the brake system. If, in contrast, compared to the historical data the recuperated energy at the same speed, is the same but the expended energy is increased, this is an indication of an impairment in the drive. It is therein possible that the energy expended is only seemingly higher, for example in that injection times are increased, in particular by extending injection durations, wherein however, reduced or the same fuel mass is introduced due to jamming or contamination of injectors. If only the recuperated energy is reduced, the recuperation is not functioning correctly. The method can be used, for example, with a rail vehicle when driving uphill, or with a mining vehicle, in particular a dump truck, which repeatedly drives down the mine and back up again.

The energy expended is in particular the energy used to provide the vehicle's drive power. This can be estimated in particular on the basis of the injection times of the internal combustion engine, since these are characteristic of the chemical energy supplied to the internal combustion engine.

According to a further development of the invention it is provided that, when traveling over the specified route, data about the vehicle or for the vehicle from along the route is detected and stored. Thus, historical data can be generated, in particular at the vehicle, via the vehicle or for the vehicle which, can be used in the future as historical data for the herein proposed method. The data can be collected in particular by the vehicle itself, for example by sensors of the vehicle, for the vehicle, for example by external sensors or surveillance cameras at stopping points, or also on the vehicle, in particular by measurements on the vehicle. Drive data, load data and/or environmental data are optionally acquired as data. The at least one power parameter is optionally detected as drive data. Loading data can be collected in particular at stopping points of the vehicle, especially at railway stations, or based on the recuperated energy. An air pressure and/or an ambient temperature of the vehicle are optionally detected as ambient or environmental data. The fact that the data is collected along the route means in particular that the data is detected in a route-section related manner.

The collected data is optionally assigned in particular to a route section on which or for which it was collected. The data is optionally stored with an information regarding the route section assigned to it. This information is also referred to as sectional route information. The data is optionally stored in the vehicle. Alternatively or additionally, it is possible for the data to be transmitted, in particular uploaded, to a central service provider.

According to a further development of the invention it is provided, that the vehicle travels multiple times over the same route. Especially in this case, the described advantages result in a special way.

According to a further development of the invention it is provided, that the vehicle is a rail vehicle or a mining vehicle. These vehicles are typically moved multiple times, in particular regularly, along the same route, so that the described advantages result in a special way.

According to a second aspect of the invention, a method is proposed for monitoring the operability of a vehicle, wherein the drive of the vehicle includes a plurality of drive units. According to a first arrangement, an operability of one drive unit of the plurality of drive units that are to be checked is assessed, in particular on the basis of the current or historical behavior of the other drive units of the plurality of drive units. In this way, information about the operability of the drive unit to be checked can be obtained reliably and with little effort, without having to examine the drive unit itself, which may be difficult precisely because of impaired operability.

The operability of the drive unit to be checked is assessed during operation of the vehicle, in particular on a route along which the vehicle moves, based on the behavior of the other drive units.

In particular, the drive unit to be checked is optionally switched off, wherein based on the behavior of the drive units that are not switched off a check is conducted as to whether the operability of the switched-off drive unit is impaired. This represents an especially simple and functionally reliable embodiment of the process. In particular, the drive unit to be checked is switched off while the vehicle is in operation, in particular on the route along which the vehicle is moving, wherein the behavior of the drive units that are not switched off is used to check whether the operability of the switched-off drive unit is impaired.

Alternatively or in addition, according to a second arrangement, at least one power parameter, optionally at least one drive parameter, of a drive unit to be checked of the plurality of drive units is compared with an expectation range, wherein the operability of the drive unit to be checked is being assessed on the basis of this comparison.

With the assistance of the procedure according to these arrangements of the second aspect of the invention, it is possible to determine, in a multi-engine system, in which one or more of the drive units there is an operational impairment.

In particular, during operation of the vehicle, especially on the route along which the vehicle is moving, the at least one power parameter of the drive unit to be checked is compared with the expectation range, and the operability of the drive unit to be checked is assessed on the basis of this comparison.

The first and/or second arrangement of the method according to the second aspect is/are thus optionally not conducted in particular in a shop or on a check bench, but instead during operation, in particular driving operation, of the vehicle. The procedure is optionally not conducted in a check mode, for example during a check drive or on a check track, but rather in regular operation, in particular in routine use. With the assistance of the method, reliable information regarding the operability of the drive can also be determined during regular operation.

The first arrangement or the second arrangement are each optionally iterated, wherein successively different drive units are treated as drive units to be checked, in particular until either an impairment is detected in one of the drive units, or until each drive unit of the plurality of drive units has been treated once as a drive unit to be checked.

Switching off the drive unit to be checked in accordance with the first arrangement occurs optionally at a constant driving power, in particular at a constant speed. In this case in particular, it can be determined whether the remaining drive units that have not been switched off have to provide the share of additional power that is mathematically attributable to them due to the deactivation of a drive unit, or a higher additional power, or a lower additional power, in order to provide the constant driving power, in particular to maintain the constant speed, compared to the operating state in which all drive units are switched on. In particular, if they have to provide a lower additional power, this suggests that the switched-off drive unit to be checked has previously, in the operating state in which all drive units are switched on, provided a reduced power in relation to the power actually to be provided by it and thus has a reduced operational capability. The remaining drive units that have not been switched off then only have to absorb this reduced, switched-off reduced power.

The following calculation example shall serve as an explanation: If a target power of 45% of the rated power is specified for each drive unit of four drive units—for example due to aging instead of 40%—the total target power corresponds to 180% of the rated power of a drive unit, whereby the drive units all have the same rated power in the example for the sake of simpler calculation. A first drive unit of the four drive units is now switched off as the drive unit to be checked. To maintain the speed, the remaining three drive units must each be operated at 60% of their rated power, which in turn corresponds to a total of 180% of the rated power of one drive unit. Accordingly, the first drive unit shows no impairment. If, in contrast, after the first drive unit has been switched off, the remaining three drive units each have to be operated at 53% of their rated power in order to maintain the speed, the operability of the first drive unit is obviously impaired, since three times 53%, thus 160% of the rated power of a drive unit, is now obviously sufficient to maintain the speed. This suggests that in the operating condition in which all four drive units were switched on, the full 180% of the rated power of one drive unit was in fact not applied, and the first drive unit can be identified as the cause for the underpower.

In the second arrangement, the expectancy range is optionally determined from historical data of the drive unit that is to be checked or, alternatively, from historical data of the other drive units. In particular, if insufficient data is available for the drive unit that is to be checked, the behavior of the drive unit to be checked can be estimated from the historical behavior of the other drive units and an expectancy range can be formed, where it can then be checked whether the at least one power parameter of the drive unit that is to be checked falls within the expectancy range. Such expectation ranges can be determined in particular through interpolation of acquired data for power parameters of the drive units. Determining the expectancy range from historical data of the other drive units in particular also represents a variant of the first arrangement in which the operability of the drive unit to be checked is assessed based on the historical behavior of the other drive units.

In a second arrangement, an injection time is optionally used, as the at least one power parameter.

The procedure according to the second arrangement will also be explained in more detail using an example: If the vehicle is driving, for example along a certain section of the route, power parameters are detected for all four drive units. During a first run, for example, the first drive unit and the second drive unit deliver 60% of their rated power, and the third drive unit and the fourth drive unit deliver 80% of rated power. During a second run on the same section of the route, the first drive unit and the third drive unit deliver 60% of their rated power, and the second drive unit and the fourth drive unit deliver 80% of their rated power. During a third run on the same section of the route, the first drive unit and the fourth drive unit deliver 60% of their rated power, and the second drive unit and the third drive unit deliver 80% of their rated power. Thus, the behavior with regard to the detected power parameter, in particular the injection times, is known for the second drive unit, the third drive unit and the fourth drive unit to be 60% of the rated power as well as 80% of the rated power. If the intent is now to form an expectancy range for the power parameter for the first drive unit at 80% of its rated power—especially for a fourth run—which is not known from the detected data, this can be estimated from the power parameters detected for the second, third and fourth drive units. It can then be checked whether the power parameter, in particular the injection time, for the first drive unit falls within the expectancy range thus formed, when it is operated at 80% of its rated power on the same section of the route. If this is not the case, it can be concluded that the operability of this first drive unit is impaired.

The first aspect and the second aspect of the invention are optionally combined. If, according to the first aspect of the invention, an impairment of the operability of the vehicle—in particular in the drive unit—is determined, it is optionally checked according to the second aspect of the invention in which drive unit of the plurality of drive units the impairment is present.

This occurs optionally according to the first arrangement of the second aspect explained above and/or according to the second arrangement of the second aspect explained above, optionally during operation, in particular during regular operation, of the vehicle, in particular on the specified route traveled according to the first aspect. This means in particular that optionally a drive unit that is to be checked of the plurality of drive units is switched off, wherein it is checked on the basis of the behavior of the drive units which are not switched off whether the impairment is present in the drive unit which is switched off, and/or that optionally at least one power parameter of a drive unit that is to be checked of the plurality of drive units is compared with an expectancy range—in a fourth comparison—wherein it is determined on the basis of the fourth comparison whether the impairment is present in the drive unit that is to be checked. The expectancy range is therein optionally determined from the historical data of the drive unit that is to be checked, or from the other drive units.

Also with this combination of the two aspects of the invention, the first arrangement and the second arrangement respectively, may optionally be iterated with respect to the drive unit that is to be checked, in particular until either a drive unit that is impaired with respect to its operability is identified, or each drive unit of the plurality of drive units has been treated once as a drive unit to be checked.

The present invention also provides a controller for a drive of a vehicle, said controller including a power detection module which is designed to detect at least one power parameter which is characteristic of a power of the drive of the vehicle. The controller also includes a comparison module which is designed to compare the at least one detected power parameter with historical data on a route traveled by the vehicle, and an evaluation module which is designed to evaluate an operability of the vehicle based on the comparison of the at least one detected power parameter with the historical data. The controller has optionally a computing device including the power detection module, the comparison module, and the evaluation module.

The control system, in particular the computing device, is optionally arranged for conducting a method according to the invention according to the first and/or the second aspect of the invention, or according to one of the previously described embodiments of the method. In connection with the control system, the advantages already explained above in connection with the methods are realized.

The controller, in particular the computing device, optionally has a data module that is designed to provide historical data on the route traveled for the comparison module. Optionally, the data module is designed to store the historical data and/or to obtain the historical data, in particular to download it from a central service provider or network.

The controller, in particular the computing device, optionally has a power detection module that is designed to capture historical data along the route traveled by the vehicle, and to store it—in particular in the data module—as historical data and/or upload it to a central service provider or network.

The controller, in particular the computing device, optionally has a network module that is designed to connect the controller, in particular the computing device, to a central service provider or a network in a data-transmitting manner.

The controller, in particular the computing device, optionally has an identification module that is designed to determine the route traveled by the vehicle, in particular to recognize it on the basis of pattern matching, optionally with the historical data of a plurality of routes.

The computing device is optionally arranged in the vehicle, in particular integrated in the vehicle. Alternatively, it is possible for the computing device to be designed as a computing device that is spatially separate from the vehicle but optionally connected to the vehicle in a data-transmitting manner, in particular as a central service provider, also known as a server, or as a cloud.

It is also possible for the controller to have two computing devices, wherein a first computing device is optionally arranged in the vehicle, optionally integrated in the vehicle, and a second computing device is designed as a central computing device, in particular a central service provider, or cloud, which is separate from the vehicle but connected to the vehicle, in particular to the first computing device, in a data-transmitting manner.

The present invention also provides a drive for a vehicle, wherein the drive has a control system according to the invention or a control system according to one of the previously described embodiments, or wherein such a control system is assigned to the drive, in other words, the drive exists in combination with the control system. The advantages already explained above are realized in particular in connection with the drive.

According to a further development of the invention, it is provided that the drive has at least one internal combustion engine and/or at least one electric machine. In an optional embodiment, the drive is an internal combustion-electric or internal combustion-hydraulic drive, a hybrid drive, in particular a parallel hybrid, or an electric drive with battery and/or fuel cell.

The present invention also provides a vehicle with a drive according to the invention or a drive according to one of the design examples described above. The advantages already explained above are realized in particular in connection with the vehicle.

The vehicle is optionally a rail vehicle or a mining vehicle.

The invention also includes a system including a vehicle with a drive and a controller, wherein the system, in particular the controller, is designed for conducting a method according to the invention according to the first and/or the second aspect of the invention, or according to one of the previously described embodiments of the method.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of an example of an embodiment of a system with an example of an embodiment of a controller for conducting a method for monitoring the operability of a vehicle, and at the same time a schematic representation of an example of an embodiment of a vehicle;

FIG. 2 is a schematic representation of a first embodiment of a method for monitoring the operability of a vehicle;

FIG. 3 is a schematic representation of a second embodiment of such a method;

FIG. 4 is a schematic representation of a third embodiment of such a method;

FIG. 5 is a schematic representation of a first further development of the first embodiment of the method; and

FIG. 6 is a schematic representation of a second development of the first embodiment of the method.

Corresponding reference characters indicate corresponding parts throughout the several views. The exemplifications set out herein illustrates embodiments of the invention, and such exemplifications are not to be construed as limiting the scope of the invention in any manner.

### DETAILED DESCRIPTION OF THE INVENTION

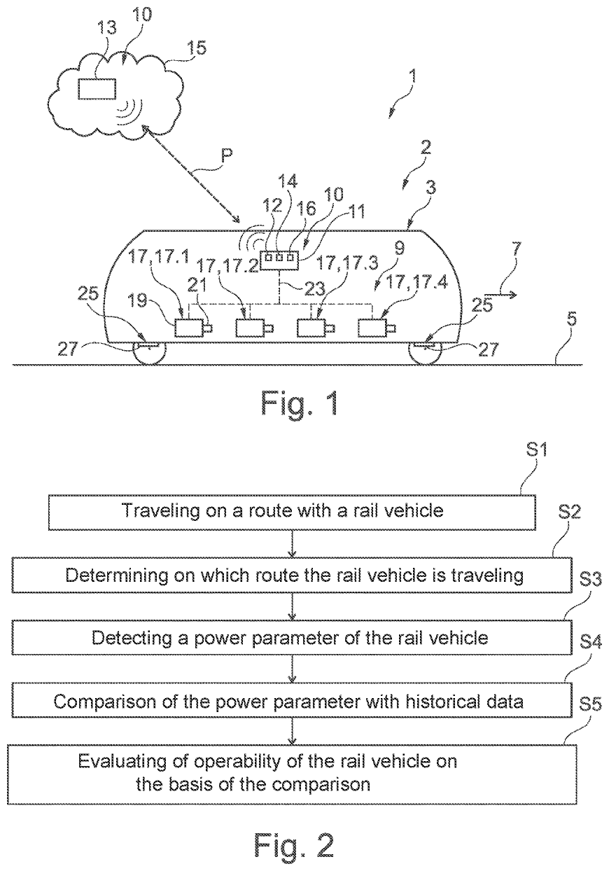

FIG. 1 shows a schematic representation of an embodiment of a system 1, illustrating an embodiment example of a vehicle 2, here as an example and in an optional embodiment a rail vehicle 3 which, for example can travel automatically on a track 5 along a route 7 schematically indicated by an arrow. Track 5 may in particular have one rail, two rails, or a number of rails greater than two. In another optional arrangement, vehicle 2 can also be a mining vehicle, in particular a dump truck, or another vehicle that is optionally moved several times, in particular regularly, along a same or the same route. The following explanation based on rail vehicle 3 is therefore not to be understood as restrictive.

In order to be able to travel automatically along route 7, rail vehicle 3 has a drive 9. System 1 further includes an example of an embodiment of a controller 10 for drive 9 of vehicle 2, and also for vehicle 2. Controller 10 includes a first computing device 11 in rail vehicle 3, in particular a control device. Controller 10, in particular first computing device 11, is in particular set up to conduct a method explained in more detail below. As a result, system 1 is also designed to conduct the method.

Computing device 11 is optionally operatively connected to drive 9, in particular in order to control drive 9 and, on the other hand, optionally in order to be able to detect at least one power parameter of drive 9.

First computing device 11 is herein arranged in rail vehicle 3.

Computing device 11 includes in particular a power detection module 12 arranged to detect at least one power parameter characteristic of a power of drive 9 of vehicle 2. Computing device 11 further includes a comparison module 14 arranged to compare the at least one detected power parameter with historical data on route 7 traveled by vehicle 2, and an evaluation module 16 arranged to evaluate an operability of vehicle 2 based on the comparison of the at least one detected power parameter with the historical data.

Alternatively it possible for system 1, in particular controller 10, to have a second computing device 13 which is arranged externally to rail vehicle 3, in particular remotely from it, wherein second computing device 13 is optionally designed as a central service provider or as a decentralized data cloud, that is to say as a cloud 15. This second computing device 13, which is external with respect to rail vehicle 3, can also be designed to conduct the method described below.

Particularly optional, however, is an embodiment of system 1 as shown in FIG. 1, in which system 1, in particular controller 10, includes first computing device 11 arranged in rail vehicle 3, in particular the control unit, and second computing device 13 arranged externally from rail vehicle 3. First computing device 11 and second computing device 13 are optionally in data-transmitting operative connection with each other, as indicated schematically here by a double arrow P. In particular, it is possible that the method is conducted in a manner, distributed on first computing device 11 and on second computing device 13. In particular, it is possible that part of the method is performed on first computing device 11 and another part of the method is performed on second computing device 13.

Drive 9 is optionally designed as a multi-motor system and in this respect has a plurality of drive units 17, in this example four drive units, in particular a first drive unit 17.1, a second drive unit 17.2, a third drive unit 17.3 and a fourth drive unit 17.4. Of course, a different, in particular smaller or larger number of drive units 17 is possible. It is also possible that drive 9 has only one drive unit 17 or is itself designed as a single drive unit 17.

Drive 9 or each of the drive units 17 can be designed in particular as an internal combustion engine, as a combustion-electric drive, as a combustion-hydraulic drive, as a hybrid drive, in particular a parallel hybrid, or as an electric machine with fuel cell or battery as energy supplier. It is possible that all drive units 17 are designed the same. It is, however, also possible that different types of drive units 17 are combined with each other. A combustion-electric drive is optionally a diesel-electric drive. A combustion-hydraulic drive is optionally a diesel-hydraulic drive. In particular, a diesel engine may be used as the internal combustion engine. However, it is also possible that a gas engine or another suitable type of engine with internal or external combustion is used as the internal combustion engine.

In the design example shown here, all four drive units 17 are optionally designed as hybrid drive units 17. Respectively, they include in particular, an internal combustion engine 19 and an electric machine 21, which for the sake of clarity is shown here explicitly with reference signs only for first drive unit 17.1. Internal combustion engine 19 and electric machine 21 respectively, can each individually or jointly provide propulsive power for rail vehicle 3.

First computing device 11 is in particular operatively connected to each of the drive units 17, in particular individually or jointly, in particular via a bus system 23 suitable for this purpose. However, each drive unit 17 can always be addressed optionally separately by first computing device 11.

FIG. 2 depicts a schematic representation of a first embodiment of a method for monitoring the operability of a rail vehicle, in particular according to the first aspect of the invention. Here, in a first step S1, specified route 7 is traveled by the vehicle 3. Optionally, in an optional second step S2, it is determined on which route rail vehicle 3 is traveling. First step S1 and optional second step S2 do not necessarily have to be conducted in the sequence shown. In particular, it is possible that the determination of the route 7 is performed by route specification, in particular by an operator of rail vehicle 3 or by a driver of rail vehicle 3, for example by the driver of rail vehicle 3 entering specified route 7 into first computing device 11 before the start of the journey. However, detection of route can also occur while traveling on same, in particular by way of optionally satellite-supported navigation and/or pattern matching.

In a third step S3, at least one power parameter of rail vehicle 3 is detected, which is characteristic in particular for a current or route-related power of drive 9. In a fourth step S4, the at least one detected power parameter is compared with historical data along traveled route 7 in a first comparison, this first comparison being conducted in particular with respect to route-section related manner.

In a fifth step S5, the operational capability of rail vehicle 3 is evaluated on the basis of the first comparison. It can thus be advantageously determined in a simple manner, and in particular without exact knowledge of the output power actually provided by rail vehicle 3 in comparison with the historical data whether rail vehicle 3 is fully operational or whether it is restricted or impaired with regard to its operability.

A target power specification for rail vehicle 3 along traveled route 7 is optionally compared in a second comparison with the at least one detected power parameter, wherein the operability of rail vehicle 3 is additionally evaluated in particular in fifth step S5 on the basis of the second comparison.

A comparison result of the second comparison is particularly optionally compared with historical data, and this comparison is also used to evaluate the operability of rail vehicle 3.

According to a optional embodiment, traveled route 7 is verified when rail vehicle 3 travels along route 7. This can occur in particular on the basis of satellite-supported navigation data. Alternatively, or in addition, verification of route 7 occurs optionally based on a pattern match comparison of the detected at least one power parameter with historical data or data patterns of the at least one power parameter.

As the at least one power parameter, the third step S3 optionally detects a parameter selected from a group consisting of: target power setting; speed of the rail vehicle 3; acceleration of rail vehicle 3; injection time of an internal combustion engine 19 of drive 9; rotational speed of the internal combustion engine 19; and an engaged or selected gear of a transmission of drive 9. At least two of these parameters are detected especially optionally as power parameters. Particularly optionally, all of the parameters mentioned here are detected as power parameters and used to evaluate the operability of rail vehicle 3.

Optionally, the first comparison and/or the second comparison considers a loading of rail vehicle 3, in particular a current loading. The loading is optionally determined by reading out historical loading data subject to time and location of rail vehicle 3, and/or by evaluating recuperated energy if rail vehicle 3 has a recuperating drive as drive 9.

If an impairment of the operability of rail vehicle 3 is detected in fifth step S5, it is optionally checked whether the impairment is present in drive 9 or in a brake system 25 of rail vehicle 3 shown in FIG. 1. This check is optionally conducted on the basis of a slope descent behavior and/or a deceleration behavior of rail vehicle 3, in particular when rail vehicle 3 is coasting. Optionally, the current slope descent behavior and/or the current deceleration behavior is compared with the corresponding historical data. Alternatively or additionally, recuperated energy is compared with expended energy of the rail vehicle in a third comparison if rail vehicle 3 has a recuperating drive, in particular by considering historical data, and the corresponding check is performed in this way. In this way, it can be determined in particular whether the impairment of operability is present in drive 9, or whether, for example, a brake 27 of brake system 25 is jammed.

When traveling on specific route 7, data from rail vehicle 3 or for rail vehicle 3, in particular on rail vehicle 3, is optionally detected and stored along route 7. In particular, drive data of drive 9, loading data for rail vehicle 3 and/or ambient data such as air pressure and air temperature are optionally detected. The data is optionally detected in a route section-related manner and assigned to the respective route section on or for which it is detected. It is then optionally stored with route-sectional information for the respective assigned route section.

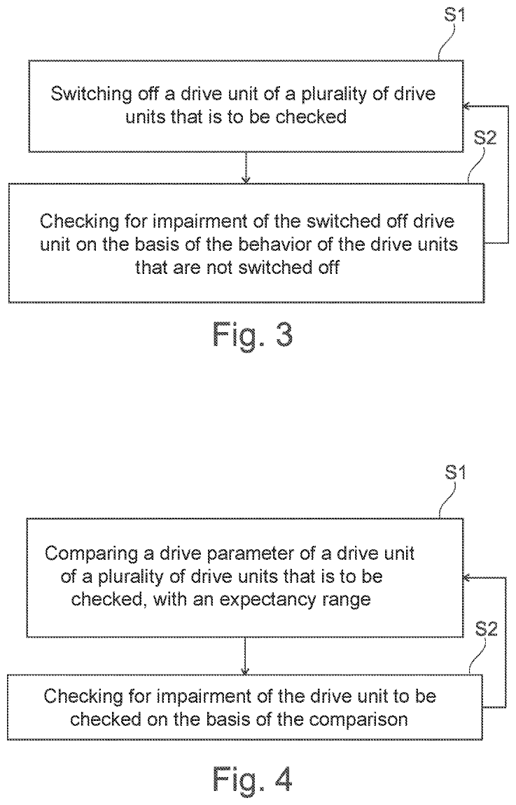

FIG. 3 is a schematic representation of a second embodiment of the method, in particular according to the second aspect of the invention. Here, an operability of a drive unit 17 of the plurality of drive units 17 which are to be checked is assessed—optionally during regular driving operation of rail vehicle 3—based on a behavior of the other drive units 17. In particular, in a first step S1 drive unit 17 which is to be checked is switched off, and in a second step S2 it is checked on the basis of the behavior of the drive units that have not been switched off as to whether there is any impairment in drive unit 17 that has been switched off. In this way, it can be determined, in particular individually for drive unit 17 whether there is an impairment of the operability. Optionally, the driving power, in particular the speed of rail vehicle 3, is kept constant during this check, whereby in particular the driving power, in particular the speed after switching off drive unit 17 which is to be checked is the same as before switching off drive unit 17 to be checked.

First step S1 and second step S2 can be iterated for further drive units 17 to be checked, in particular until either an impairment is detected in one of drive units 17, or until each of the drive units 17 has been treated at least once as a drive unit to be checked in other words, has been switched off.

FIG. 4 is a schematic representation of a third embodiment of the method, in particular according to the second aspect of the invention. Here, in a first step S1, at least one power parameter of a drive unit 17 of the plurality of drive units 17 to be checked is compared—optionally in regular driving operation of rail vehicle 3—with an expectation range, the expectancy range optionally being determined from historical data of drive unit 17 which is to be checked or of the other drive units 17. In a second step S2, this comparison is used to determine whether drive unit 17 to be checked has an impairment of its operability. In this manner, it can also be checked individually whether one of the drive units 17 has an impairment of its operability, and which one this is. In this case, too, first step S1 and second step S2 can be iterated, in particular until either an impairment of the operability of one of the drive units 17 has been determined, or until each of the drive units 17 has been treated at least once as a drive unit 17 to be checked in which case, in particular, the at least one power parameter for this drive unit 17 to be checked has been compared with the corresponding expectancy range and the operability has been checked on the basis of this comparison.

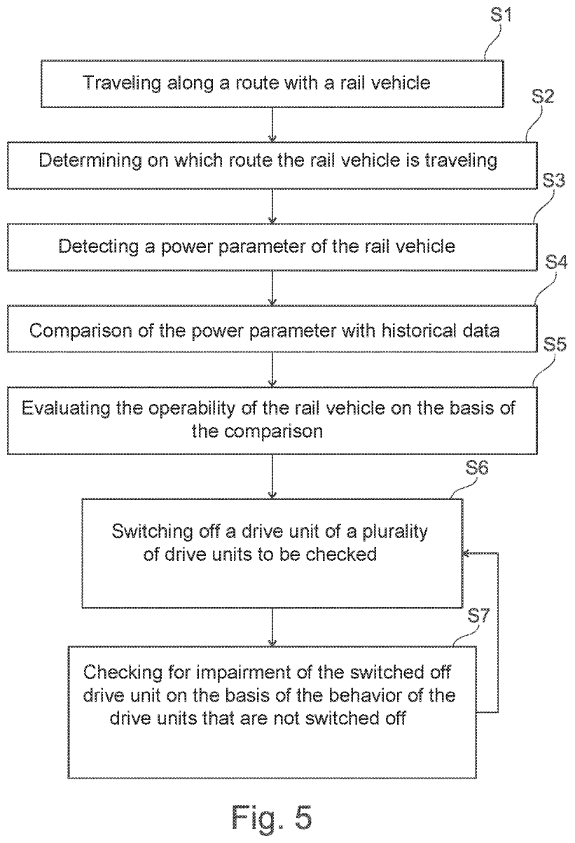

FIG. 5 is a schematic representation of a further development of the first embodiment of the method according to FIG. 2. Herein, first five steps S1 to S5 are consistent with the five steps S1 to S5 according to FIG. 2. If, in fifth step S5 an impairment is detected in drive 9, sixth step S6 and seventh step S7 are then used—optionally still on same traveled section 7—to check in which drive unit 17 of the plurality of drive units 17 the impairment is present, wherein the second embodiment of the method according to FIG. 3 is used in this first further development. Thus, sixth step S6 corresponds with first step S1 according to FIG. 3, and seventh step S7 corresponds with second step S2 according to FIG. 3. Thus, in sixth step S6, a drive unit 17 of the plurality of drive units 17 to be checked is switched off, and in seventh step S7, based on the behavior of drive units 17 that have not been switched off a check is conducted, as to whether the impairment is present in drive unit 17 that has been switched off. Also in this case, sixth step and seventh step S6, S7 can be iterated as previously explained in connection with FIG. 3. Thus, it can be individually verified in which of the drive units 17 the detected impairment is present.

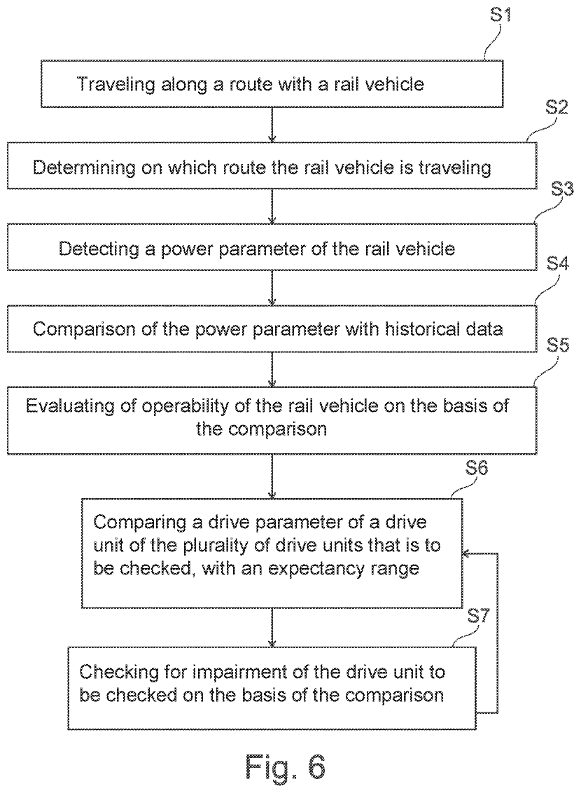

FIG. 6 is a schematic representation of a second further development of the first embodiment of the method according to FIG. 2. Here again, the first five steps S1 to S5 correspond to the five steps S1 to S5 according to FIG. 2. If an impairment of the operability of rail vehicle 3 in drive 9 is now detected here in the fifth step S5, a sixth step S6 and a seventh step S7—optionally still on the same traveled route 7—are used to check in which drive unit 17 of a plurality of drive units 17 the impairment is present. In this design it is therefore also possible to identify precisely in which drive unit 17 the impairment is present. Here, sixth step S6 and seventh step S7 correspond with the third embodiment of the method according to FIG. 4; in other words, sixth step S6 corresponds with first step S1 according to FIG. 4, and seventh step S7 corresponds with second step S2 according to FIG. 4. Thus, in sixth step S6, at least one power parameter of a drive unit 17 that is to be checked of the plurality of drive units 17 is compared in a fourth comparison with an expectancy range, which is optionally determined from historical data of drive unit 17 that is to be checked or of the other drive units 17. In seventh step S7, the fourth comparison is used to determine whether the impairment is present in drive unit 17 that is to be checked. Also in this case, sixth step S6 and seventh step S7 may be iterated until either it is determined in which of the drive units 17 the impairment is present, or until each of the drive units 17 has been used at least once as the drive unit 17 that is to be checked.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for monitoring an operability of a vehicle, the method comprising the steps of:
traveling a route, which is defined, with the vehicle;
detecting at least one power parameter of the vehicle, the at least one power parameter being characteristic for a power of a drive of the vehicle;
comparing, in a first comparison, the at least one power parameter with historical data regarding the route traveled; and
evaluating the operability of the vehicle based on the first comparison.

2. The method according to claim 1, wherein a target power specification for the vehicle is compared in a second comparison along the route traveled with the at least one power parameter which has been detected, wherein the operability of the vehicle is additionally evaluated based on the second comparison.

3. The method according to claim 1, wherein the route traveled is verified during a travel on the route with the vehicle, at least one of based on navigational data and based on a pattern matching of the at least one power parameter, which has been detected, with historical data.

4. The method according to claim 1, wherein as the at least one power parameter, a parameter is detected which is selected from a group consisting of: a target power specification; a speed of the vehicle; an acceleration of the vehicle; an injection time of an internal combustion engine of the drive; a rotational speed of the internal combustion engine; and a selected gear of a transmission of the drive.

5. The method according to claim 1, wherein during at least one of the first comparison and a second comparison, a load of the vehicle is considered, wherein the load is determined by at least one of:
a) reading out historical load data depending on a time and a location; and
b) evaluating a recuperated energy if the vehicle has a recuperative drive as the drive.

6. The method according to claim 1, wherein, when an impairment of the operability of the vehicle is detected, the method includes a step of checking whether the impairment is present in the drive or in a brake system of the vehicle, wherein the step of checking is performed based on at least one of:
a) a behavior during at least one of a slope descent and a deceleration of the vehicle, by comparing at least one of a current slope descent behavior and a current deceleration behavior with historical data; and
b) a comparison of a recuperated energy with an expended energy of the vehicle, if the vehicle has a recuperative drive, by considering historical data.

7. The method according to claim 1, wherein, when traveling over the route which is specified, data about the vehicle or for the vehicle from along the route is detected and stored.

8. The method according to claim 1, wherein the vehicle travels multiple times over a same one of the route.

9. The method according to claim 1, wherein the vehicle is a rail vehicle or a mining vehicle.

10. The method according to claim 1, wherein the drive of the vehicle comprises a plurality of drive units, wherein at least one of:
a) an operability of one drive unit of the plurality of drive units is assessed based on a behavior of other ones of the plurality of drive units; and
b) the at least one power parameter of a respective drive unit that is to be checked of the plurality of drive units is compared—thereby providing a comparison—with an expectancy range which is determined from historical data of the respective drive unit that is to be checked or of other ones of the plurality of drive units, wherein the operability of the respective drive unit that is to be checked is assessed based on the comparison.

11. A controller for a drive of a vehicle, the controller comprising:
a power detection module configured for detecting at least one power parameter which is characteristic of a power of the drive of the vehicle;
a comparison module configured for comparing the at least one power parameter, which has been detected, with historical data on a route traveled by the vehicle; and
an evaluation module configured for evaluating an operability of the vehicle based on a comparison of the at least one power parameter, which has been detected, with the historical data.

12. A drive for a vehicle, the drive comprising:
a controller, comprising:
a power detection module configured for detecting at least one power parameter which is characteristic of a power of the drive of the vehicle;
a comparison module configured for comparing the at least one power parameter, which has been detected, with historical data on a route traveled by the vehicle; and
an evaluation module configured for evaluating an operability of the vehicle based on a comparison of the at least one power parameter, which has been detected, with the historical data.

13. The drive according to claim 12, further comprising at least one of at least one internal combustion engine and at least one electric machine.

14. The drive according to claim 12, wherein the drive is configured for being a part of the vehicle.

15. The drive according to claim 14, wherein the vehicle is a rail vehicle or a mining vehicle.
